(19) United States
(12) Patent Application Publication
(10) Pub. No.: US 2023/0270628 A1
(43) Pub. Date: Aug. 31, 2023

(54) Medication Case for Tracking Medication use

(71) Applicant: Kevin Darrel Taylor, Farr West, UT (US)

(72) Inventor: Kevin Darrel Taylor, Farr West, UT (US)

(21) Appl. No.: 18/174,620

(22) Filed: Feb. 25, 2023

Related U.S. Application Data
(60) Provisional application No. 63/313,801, filed on Feb. 25, 2022.

(51) Int. Cl. A61J 1/18; A61J 1/03; A61J 7/02

(52) U.S. Cl. CPC A61J 1/18; A61J 1/03; A61J 7/02; A61J 2205/50; A61J 2200/30

(57) ABSTRACT

A medication case is disclosed. The medication case includes a lid. A tracker comprising day indicators for identifying the day of the week. At least one medication indicator for identifying the number of pills taken. A slider for each indicator to be moved and identify the day of the week on the day indicator, and to identify the number of pills on the pill indicator; and a base divided into compartments. In a second aspect, the medication case comprises a lid. A tracker comprising a tracking plate with day indicators for identifying the day of the week, and at least one medication indicator for identifying the number of pills taken. A slider for each indicator to be moved and identify the day of the week on the day indicator, and to identify the number of pills on the pill indicator; and a base divided into compartments.

### CROSS-REFERENCE TO RELATED APPLICATIONS

This application is a continuation-in-part of U.S. Provisional Patent Application No. 63/313,801, filed Feb. 25, 2022, and entitled “Travel Pill Case for Tracking Medication Use” the entire disclosure of which is incorporated herein by reference.

### TECHNICAL FIELD

Medication tracking and transport.

### BACKGROUND

Patients are often required to self-administer medication according to a prescribed schedule. Adherence to, or compliance with, a medication regimen is generally defined as the extent to which patients take medications as prescribed by their health care providers. Self-admiration of such medication generally occurs over a period of time according to a prescribed dosage and schedule. Lack of adherence to a prescription is one of the leading problems with self-administration of medication today. According to the World Health Organization, medication adherence can have a more direct impact on patient outcomes than the specific treatment itself. Medication adherence can affect quality and length of life, health outcomes, and overall healthcare costs. Similar to medication, supplements often require periodic administration of tablets and pills defined by a predetermined schedule.

Since many medications, especially powerful drugs for pain, insomnia, depression and other purposes, require an accurate administration of the prescribed dosage at predetermined times missing a prescribed dose, or accidentally taking an additional dose potentially causing an overdose, can have severe consequences. It is extremely important that the person, such as a patient, keep an accurate record of the doses taken so that over administration, or under administration, of the prescribed medication does not occur. It is also important that dosages not be omitted such that continuous administration of the appropriate dose and the desired treatment is maintained.

One problem of maintaining a properly timed ingestion of the accurately prescribed dosage of medicine is of particular concern with elderly people or other people whose judgement and memory may have a tendency to forget when, which, and whether a dose of medication has been taken. This problem can also be increased when the medication itself may cause cognitive limitations. This problem is even more prevalent when the patient requires taking more than one dose of medicine on a daily basis often in the form of multiple daily pills or tablets.

### SUMMARY

In a first aspect, the disclosure provides a medication case comprising. The medication case includes a lid. A tracker comprising day indicators for identifying the day of the week. At least one medication indicator for identifying the number of pills taken. A slider for each indicator to be moved and identify the day of the week on the day indicator, and to identify the number of pills on the pill indicator; and a base divided into compartments.

In a second aspect, the disclosure provides a medication case. The medication case comprising a lid. A tracker comprising a tracking plate with day indicators for identifying the day of the week, and at least one medication indicator for identifying the number of pills taken. A slider for each indicator to be moved and identify the day of the week on the day indicator, and to identify the number of pills on the pill indicator; and a base divided into compartments.

In a third aspect, the disclosure provides a medication case. The medication case comprising a lid. A tracker comprising a tracking plate with day indicators for identifying the day of the week, and at least one medication indicator for identifying the number of pills taken. A slider for each indicator comprising. A slider stem, two retention wings, and a face plate with a handle. The sliders are configured to be moved and identify the day of the week on the day indicator, and to identify the number of pills on the pill indicator. A base divided into compartments.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a perspective view of the case in a closed position

FIG. 2 is perspective view of the case in the open position.

FIG. 3 is a perspective view of the case in the open position.

FIG. 4 is a view of a tracking plate which fits in the lid of the medication case.

FIG. 5 is a view of a slider for use with the tracking plate.

FIG. 6 is a view of a medication case in the open position.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Traditionally, medication boxes have been used with individual compartments for the days of the week. Some designs may have multiple dose compartments for each day, for doses up to four times a day, for example. While such medication boxes are indicative of whether a dose for a particular day or dosing interval has been taken, they are also inconvenient to the patient since they are often bulky and must be carried around separately from the patient's medication. Also, the patient must remember to distribute the doses of medication into the appropriate boxes each week prior to the time that the dose must be taken. Other approaches can include a variety of reminders and organizers. Reminders might include a timer or alarm that alerts a person to take a pill.

Other products on the market include electronic readers or monitors which are wirelessly connected to your phone or have an LCD screen that is mounted to the container which have multiple compartments and lids with markings which indicate the day of the week. To have a container which allows multiple doses per day, and seven days in a week, becomes very large and cumbersome. And for a single prescription bottle such conventional designs are cumbersome and extreme overkill as to a more simplified and intuitive approach.

Another problem with traditional alarm and reminder systems is that it is not always set up or programmed correctly by the patient. As previously discussed, the patient may be particularly prone to forget their medication. Similarly, the same patient may be particularly prone to set up a reliable reminder or alarm system.

Similarly some conventional reminder systems suffer from a shortcoming in that it is not readily apparent that a previous administration of medication has been missed. That is, should a previous administration of medication be missed for whatever reason, for example a forgotten setting or reset, it is not readily apparent that such a missed administration of medication has occurred.

The Pill Popper Go is a unique travel pill case with a built in tracker on the inside lid. A standard pill box will typically have 7 compartments to put pills inside for each day of the week and helps a user keep track of what they need to take for each day and if they took it. However, this requires loading the pill box for each day and refilling it again each week. With the Pill Popper Go there are 3 compartments inside the travel size box that can either hold 3 days worth of doses, or 3 different types of medicine that are separated by the dividers and not mixed together. Someone may also choose to put the same medicine in all three compartments and use the trackers in the lid to track their dose usage.

There are 3 vertical sliders and one horizontal slider in the lid. The horizontal slider will allow users to track each of the 7 days of the week. Starting with Sunday and going from left to right to Monday, Tuesday and so on until Saturday. The 3 vertical sliders will each be positioned over the 3 compartments where the pills are stored. The starting position for the vertical sliders is 0 and then they can be moved down to 1, 2 or 3 which indicates the number of doses taken in a day. The way this can work is the Pill Popper Go can have medication A in compartment 1 and it requires only 1 dose a day, but medication B in compartment 2 requires 3 doses a day. The user will set the horizontal slider to W (to indicate Wednesday, the current day) and then they will set the vertical sliders for compartments 1 and 2 (medications A and B, respectively) to the 1 position after they take their first dose for the day. Later in the day when they need to take the second dose for medication B they will set the slider for compartment 2 only to a 2, to indicate they took a 2^{nd} dose and then in the evening after completing their 3^{rd} dose they will set the slider to position 3.

The next morning (Thursday) the user will slide the horizontal tracker from W to Th and reset the vertical trackers back to 0 until they take their doses again for the new day.

There are many other travel pill cases on the market, but the thing that makes the Pill Popper Go the most different is the unique tracking sliders fixed inside the lid. This allows users to keep track of their dose intake without the need of writing utensils or extra apps. The size of the Pill Popper Go is approximately 3.75″ wide by 2.75″ tall and ⅝″ thick.

There is also an additional feature of a small round opening on the outside of the case that will accommodate a small key ring or chain to allow for attachment of the case to a bag or lanyard.

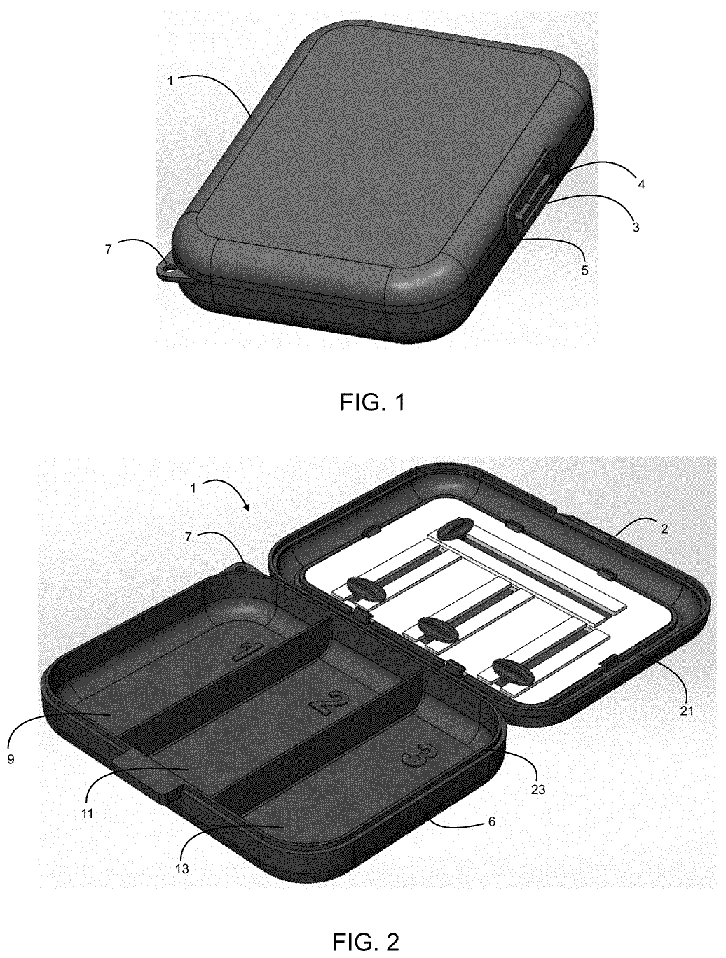

Now referring to FIG. 1, the travel case 1, referred to as the pill popper go is a case is travel size case. The pill popper go is designed to be easily carried in a pocket, purse, or small bag. In some embodiments, the pill popper go is between 4.5 inches and 3 inches long. In some embodiments, the pill popper go is between 4.25 inches and 3.25 inches long. In some embodiments, the pill popper go is between 4 inches and 3.5 inches long. In some embodiments, the pill popper go is 3.75 inches long. In some embodiments, the pill popper go is between 3.5 inches and 2 inches wide. In some embodiments, the pill popper go is between 3.25 inches and 2.25 inches wide. In some embodiments, the pill popper go is between 3 inches and 2.5 inches wide. In some embodiments, the pill popper go is 2.75 inches wide. In some embodiments, the pill popper go is between 1 inch and ¼ inch thick. In some embodiments, the pill popper go is between ⅞ inch and ⅓ inch thick. In some embodiments, the pill popper go is ⅝ inch thick.

The pill popper go includes an attachment portion 7 where a ring such as a key ring or a lanyard is attached. The case includes a locking latch 3, to keep the case closed. The locking latch includes an inner 4 and an outer locking ring 5. The outer locking ring 5 fits around the inner 4 and locks the case in the closed position.

Referring to FIG. 2, the case 1 has a lid 2 and a base 6. The inner compartment of the base 6 of the case 1 is divided into three compartments 9, 11, and 13. The lid 2 and base 6 of the case 1 interlock so as to create a weather resistant seal to protect the contents carried in the case. The seal is made up of a lip or depression 21 on the lid 2 which fits outside a protrusion 23 on the base 6. The lip or depression 21 and protrusion 23 fit together and seal the case against ingress of contaminates especially liquids.

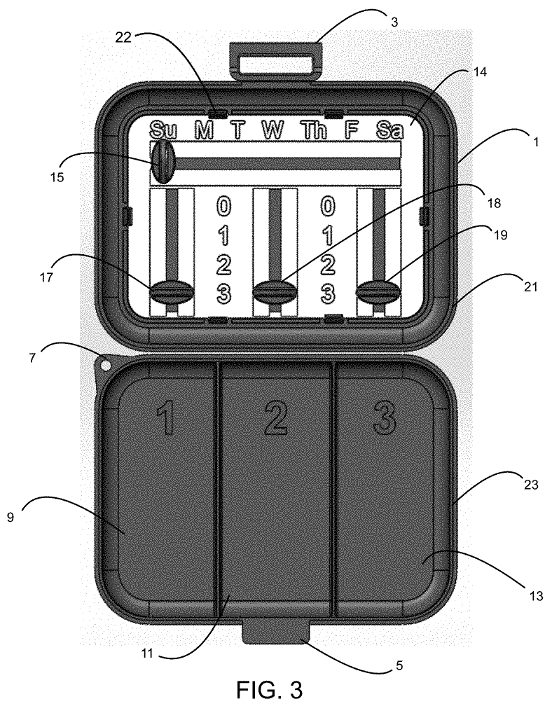

Referring to FIG. 3, the pill popper go is a case is travel size case. The pill popper go is designed to be easily carried in a pocket, purse, or small bag. In some embodiments, the pill popper go is between 4.5 inches and 3 inches long. In some embodiments, the pill popper go is between 4.25 inches and 3.25 inches long. In some embodiments, the pill popper go is between 4 inches and 3.5 inches long. In some embodiments, the pill popper go is 3.75 inches long. In some embodiments, the pill popper go is between 3.5 inches and 2 inches wide. In some embodiments, the pill popper go is between 3.25 inches and 2.25 inches wide. In some embodiments, the pill popper go is between 3 inches and 2.5 inches wide. In some embodiments, the pill popper go is 2.75 inches wide. In some embodiments, the pill popper go is between 1 inch and ¼ inch thick. In some embodiments, the pill popper go is between ⅞ inch and ⅓ inch thick. In some embodiments, the pill popper go is ⅝ inch thick.

The pill popper go includes an attachment portion 7 where a ring such as a key ring or a lanyard is attached. The case includes a locking latch 3, to keep the case closed. The locking latch includes an inner 4 and an outer locking ring 5. The outer locking ring 5 fits around the inner 4 and locks the case in the closed position.

The case 1 has a lid 2 and a base 6. The inner compartment of the base 6 of the case 1 is divided into three compartments 9, 11, and 13. The lid 2 and base 6 of the case 1 interlock so as to create a weather resistant seal to protect the contents carried in the case. The seal is made up of a lip or depression 21 on the lid 2 which fits outside a protrusion 23 on the base 6. The lip or depression 21 and protrusion 23 fit together and seal the case against ingress of contaminates especially liquids.

Within the lid is a tracker, the tracker includes tracker plate 14. The tracker includes a slider 15 for marking the day when a pill needs to be taken. The slider 15 is moved between markings for each day. Additionally, there are three sliders 17, 18, and 19 to mark the number of pills taken. The sliders can mark the number of pills taken. The sliders 17, 18, and 19 can correspond to a compartment in the base 6 mark when each of those pills has been consumed. For example, slider 17 could correspond to compartment 9 (which is marked on the base as compartment 1), slider 18 could correspond to compartment 11 (which is marked on the base as compartment 2), slider 19 could correspond to compartment 13 (which is marked on the base as compartment 3). The tracker plate 14 is held in place by tabs such as tab 22. The tabs are designed so that the plate is secured to the lid when the plate is put in place. In some embodiments, the medical travel case includes three compartments. In some embodiments, the medical travel case includes other numbers of compartments. In some embodiments, the number of compartments is seven. In other embodiments, the number of compartments is ten. In some embodiments, the compartments are lined up next to one another. In some embodiments, the compartments are arranged stacked and lined up together.

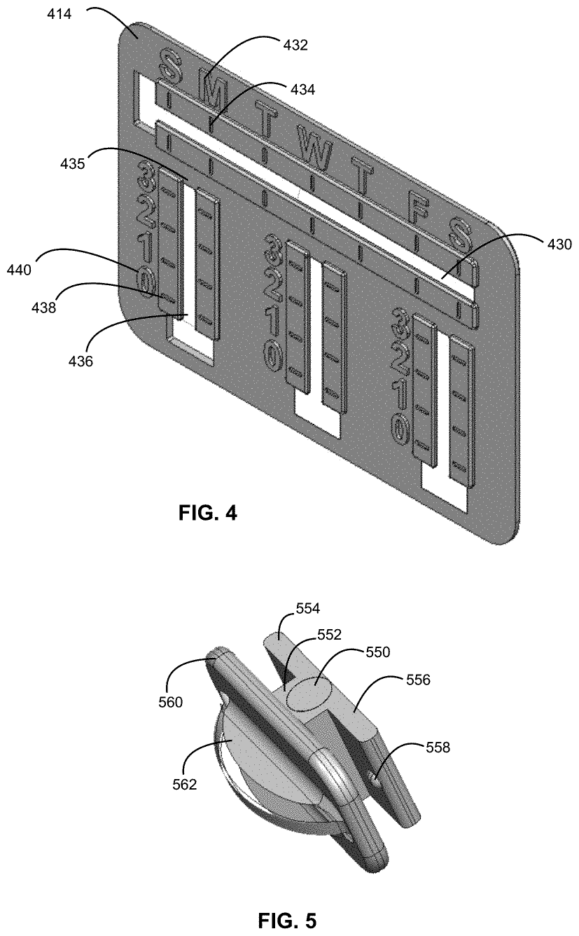

FIG. 4 is a view of the tracker plate 414. The tracker plate fits in the lid of the medical travel case. The tracker plate 414 is designed to track the days and the pills taken. The tacker plate includes a day slider canal 430. The day slider canal 430 is used in conjunction with a slider to identify the day for which pills are being taken. A slider, as seen in FIG. 5 slides along the canal and indicates which day is being identified. The tracker plate 414 includes abbreviations for each of the days such as day identifier 432. There are day identifiers for each day of the week. Corresponding to each day identifier is a slider click such as slider click 434. These slider clicks help the slider stay in position until a user moves the slider.

The tracker plate includes pill indicators. The pill indicators such as pill indicator 435. These indicators assist a user in knowing how many pills a user has taken. The indicators include an indicator canal such as indicator canal 436. A slider slides along the indicator canal and indicates the number of pills a user has taken. The indicator also includes number identifiers such as identifier 440. Each identifier corresponds to a slider click such as slider click 438. The slider clicks help keep the slider in place until a user moves it to another slider click and identifier.

FIG. 5 is a view of a slider. The slider 550 is used with the tracking plate of FIG. 4 to identify the day of the week and the number of pills a user has taken. The slider has a slider stem 552 which fits within the canals of the tracking plate. The slider includes retention wings 554 and 556 which, with the front face 560, secure the slider to the tracking plate. The distance between the front plate 560 and the retention wings is at least the same as the thickness of the tracking plate. In most embodiments, the distance between the retention wings and the front plate is greater than the thickness of the tracking plate. A grip sphere such as grip sphere 558 helps lock the slider in place. The grip spheres lock into the slider clicks described above and keep the slider from moving until a user moves the slider. In some embodiments, the grip sphere is located on the retention wings, as shown in FIG. 5. In some embodiments, the grips spheres are located on the backside of front plate 560. In some embodiments, the grips spheres are located on both the backside of the front plate and on the retention wings. The slider also includes a handle 562. The handle 562 assists in pushing the slider. The handle gives greater purchase for a finger or thumb of a user to move the slider.

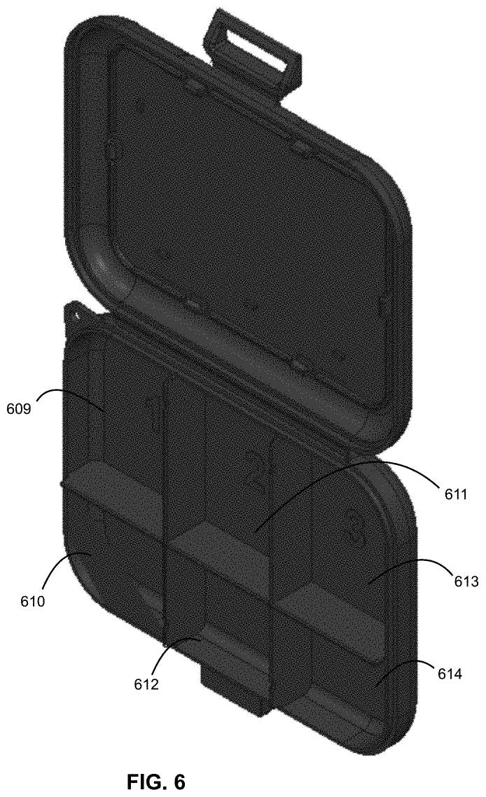

FIG. 6 is a view of a medical travel case with 6 compartments. Compartments 609, 611, and 613 are numbered and correspond to sliders on the tracking plate. Compartments 610, 612, and 614 are bonus compartments and do not necessarily correspond to sliders on the tracking plate. In many instances it is beneficial to keep all of one's medical treatments in one location. The numbered compartments are then used to hold medications that a user needs to take on a regular basis, such as every day. The bonus compartments are then used to hold medications that are used on an as needed basis. This enables multiple different medications to be carried in the same travel case.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A medication case comprising:
a lid;
a tracker comprising:
day indicators for identifying the day of the week;
at least one medication indicator for identifying the number of pills taken;
a slider for each indicator to be moved and identify the day of the week on the day indicator, and to identify the number of pills on the pill indicator; and
a base divided into compartments.

2. The medication case of claim 1, wherein each slider locks in place on its indicator and will be moved with the assistance of a user.

3. The medication case of claim 2, wherein the at least one medication indicator corresponds to at least one compartment in the base.

4. The medication case of claim 3, wherein the sliders indicate the number of doses taken on a particular day.

5. The medication case of claim 1, further comprising three compartments.

6. The medication case of claim 5, further comprising three medication indicators, each indicator corresponding to a compartment.

7. The medication case of claim 1, further comprising 6 compartments.

8. The medication case of claim 6, wherein three of the compartments correspond to three medication indicators, and three compartments are bonus compartments.

9. The medication case of claim 1, wherein the case is weather resistant.

10. The medication case of claim 1, wherein the case locks shut.

11. The medication case of claim 1, wherein the case is travel sized.

12. The medication case of claim 2, wherein the case is sized to fit in a pocket.

13. A medication case comprising:
a lid;
a tracker comprising:
a tracking plate with day indicators for identifying the day of the week, and at least one medication indicator for identifying the number of pills taken;
a slider for each indicator to be moved and identify the day of the week on the day indicator, and to identify the number of pills on the pill indicator; and
a base divided into compartments.

14. The medication case of claim 13, wherein the at least one medication indicator corresponds to at least one compartment in the base.

15. The medication case of claim 14, wherein the sliders indicate the number of doses taken on a particular day.

16. The medication case of claim 13, further comprising three compartments.

17. The medication case of claim 16, further comprising three medication indicators, each indicator corresponding to a compartment.

18. The medication case of claim 13, further comprising 6 compartments.

19. The medication case of claim 18, wherein three of the compartments correspond to three medication indicators, and three compartments are bonus compartments.

20. A medication case comprising:
a lid;
a tracker comprising:
a tracking plate with day indicators for identifying the day of the week, and at least one medication indicator for identifying the number of pills taken;
a slider for each indicator comprising:
a slider stem;
two retention wings;
a face plate with a handle;
wherein the sliders are configured to be moved and identify the day of the week on the day indicator, and to identify the number of pills on the pill indicator; and
a base divided into compartments.
